(19) United States
(12) Patent Application Publication
(10) Pub. No.: US 2026/0188757 A1
(43) Pub. Date: Jul. 2, 2026

(54) ZINC-GRAPHITE BATTERY BASED ON BROMINE CHEMISTRY ENABLED BY WATER-IN-SALT ELECTROLYTE

(71) Applicant: UNIVERSITY OF SHARJAH, Sharjah (AE)

(72) Inventors: Sirugaloor Thangavel SENTHILKUMAR, Sharjah (AE); Maryam Mohd Haitham MOUSELLY, Sharjah (AE); Javad Basil Marutheri PARAMBATH, Sharjah (AE); Anis ALLAGUI, Sharjah (AE); Hussain ALAWADHI, Sharjah (AE)

(21) Appl. No.: 19/437,973

(22) Filed: Dec. 31, 2025

Related U.S. Application Data
(60) Provisional application No. 63/740,534, filed on Dec. 31, 2024.

(51) Int. Cl. H01M 10/26; H01M 4/38; H01M 4/583

(52) U.S. Cl. CPC H01M 10/26; H01M 4/38; H01M 4/583; H01M 2300/0011

(57) ABSTRACT

The present disclosure discloses a zinc-graphite battery based on bromine chemistry enabled by water-in-salt electrolyte is disclosed. The battery comprises a foil selected to serve as a cathode host for the electrochemical reactions involving bromide ions, an anode selected from zinc foil or graphite foil that serves as a current collector for zinc deposition and dissolution, and water-in-salt electrolyte (WiSE) comprising lithium chloride (LiCl), zinc chloride (ZnCl₂), and potassium bromide (KBr). The WiSE provides bromide ions for cathodic reactions and zinc ions for anodic reactions. During charging, bromide ions are oxidized to bromine at the cathode and converted into tribromide, with subsequent bromine intercalation between graphene layers of the graphite foil, while zinc ions are deposited as metallic zinc at the anode. The battery achieves high discharge capacity, coulombic efficiency of not less than 91%, high-power density up to 199.5 mW/cm², and extended cycle life of at least 800 cycles with a zinc foil anode or at least 1100 cycles with a graphite foil anode.

### FIELD

The present disclosure relates to the field of electrochemical energy storage, and more particularly to zinc-graphite batteries utilizing bromine chemistry enabled by water-in-salt electrolytes.

### BACKGROUND

Background description includes information that will be useful in understanding the present invention. It is not an admission that any of the information provided herein is prior art or relevant to the presently claimed invention, or that any publication specifically or implicitly referenced is prior art.

Lithium-ion batteries (LIBs) are Lithium-ion batteries (LIBs) are widely used in electronics and electric vehicles, but their high cost and safety concerns make them unsuitable for gigawatt-scale energy storage. The expense is mainly tied to electrode materials (anode and cathode) and electrolytes, with safety issues stemming from the volatile nature of electrolytes. This necessitates the development of alternative rechargeable batteries using inexpensive, sustainable resources, including safer electrolytes. Aqueous zinc-graphite batteries (ZnGBs) with dual-ion chemistry (anion insertion at the graphite positive electrode and Zn²⁺ cation deposition at the negative electrode) have recently emerged as competitive alternatives to LIBs. Main cell components such as zinc, graphite, and aqueous electrolytes are safer, low-cost, recyclable, and environmentally friendly.

Conventional aqueous electrolytes are unsuitable for use in ZnGBs. In such instances, works on ZnGBs commonly employ highly salt-concentrated aqueous electrolytes known as water-in-salt electrolytes (WiSEs). WiSEs are preferred because they significantly expand the stability window of water and enable ZnGBs to operate at voltages of approximately 2.5-2.8 V. WiSEs that consist of polyatomic anions such as TFSI⁻, FSI⁻, OTf⁻, and ClO₄⁻, as well as metal halide complex anions like [ZnClₓ]^{2-x}, have been primarily investigated as direct intercalating anions in graphite. Unfortunately, these anions deliver low discharge capacities, which are significantly lower than the theoretical capacity of zinc. This limitation can hamper the energy density of ZnGBs. Furthermore, some of these anions exhibit shorter discharge voltage plateaus, covering only around 30-50% of the total capacity, and they also result in poor coulombic efficiency, often falling below 80%.

Dual halogens, specifically bromine (Br) and chlorine (Cl) storage chemistry at graphite, have recently been explored in WiSE Li-based batteries. This approach was later extended to ZnGBs using a molten hydrate electrolyte. Notably, Br and Cl storage in graphite resulted in a high discharge capacity and a stable discharge voltage plateau for ZnGBs compared to polyatomic anions and metal halide complex anions storage chemistry. However, chloride ion (Cl⁻) participation in the reaction process during charge can alter electrolyte properties and induce oxidation/corrosion of the graphite electrode, thereby limiting the ZnGB's cycles to 100. Unfortunately, both molten hydrate electrolytes and water-salt oligomer electrolytes suffer from common limits: they exhibit poor capacity rate capability and low current density performance. These limits are likely caused by the low ionic conductivity of the electrolytes and the slow transport of redox-active ions to the graphite electrode. High current operation is crucial for batteries for large-scale energy storage applications, enabling rapid energy storage and high-power density.

### SUMMARY

Aqueous zinc-graphite batteries (ZnGBs) have recently been explored as high-voltage and low-cost options with the hope of scalable energy storage systems. However, the adopted polyatomic and metal complex anion intercalation process at the graphite cathode electrode exhibits poor electrochemical performance. As an alternative, halogen anions, due to their redox process, were identified to offer exceptional electrochemical performance to the graphite cathode electrode compared to polyatomic and metal complex anions. In this work, ZnGBs were established using a liquid water-in-salt-electrolyte (WiSE), which can efficiently offer the required Br− halogen ions to achieve the bromine conversion (Br3−) and intercalation (Br2) process at the graphite cathode electrode. These processes resulted in a 2.73 mAh/cm2 discharge capacity with 91% coulombic efficiency (CE), and high current density operation up to 150 mA/cm2 was achieved for the ZnGB. Additionally, with a high-power density (199.5 mW/cm2) and excellent rate capability (reaching ˜93% CE at 150 mA/cm2), the ZnGB ran for 800 repeated cycles. Beguilingly, Zn metal-free ZnGB ran with enhanced cycles up to 1100 without noticeable performance decay and achieved electrochemical performance like the Zn metal anode used in ZnGB. This work provides an understanding of the reaction process of Br involved in graphite electrodes, thereby offering an opportunity to further advance ZnGB by utilizing bromine chemistry.

There is provided, according to a first aspect of the present disclosure, a zinc-graphite battery based on bromine chemistry enabled by water-in-salt electrolyte, comprising: a graphite foil selected to serve as a cathode host for the electrochemical reactions involving bromide ions; an anode selected from zinc foil or graphite foil that serves as a current collector for zinc deposition and dissolution; and a water-in-salt electrolyte (WiSE) comprising lithium chloride (LiCl), zinc chloride (ZnCl₂), and potassium bromide (KBr), wherein the WiSE provides bromide ions for cathodic reactions and zinc ions for anodic reactions.

Advantageously, the inventors have found that ZnGBs established using a liquid water-in-salt electrolyte (WiSE) can efficiently offer the required Br⁻ halogen ions to achieve the bromine conversion (Brₓ⁻(x=2n+1)) and intercalation (Br₂) process at the graphite cathode electrode. These processes may result in a 2.73 mAh/cm² discharge capacity with 91% coulombic efficiency (CE), and high current density operation up to 150 mA/cm². Additionally, with a high-power density (199.5 mW/cm²) and excellent rate capability (reaching approximately 93% CE at 150 mA/cm²), the ZnGB may run for 800 repeated cycles. Furthermore, a Zn metal-free ZnGB may run with enhanced cycles up to 1100 without noticeable performance decay and achieve electrochemical performance like the Zn metal anode used in ZnGB.

According to embodiments of the present disclosure, the graphite foil may be directly used as a cathode host material without comprising a binder or a carrier. This configuration allows the graphite foil to be used as the direct positive electrode, which may simplify manufacturing, reduce material costs, and improve electrical conductivity by eliminating resistive interfaces introduced by binders.

According to embodiments of the present disclosure, the battery may comprise a floating-type cell configuration without a separator or membrane, wherein a safe distance is maintained between the cathode and anode to prevent short circuits and dendrite growth. WiSEs are preferred because they significantly expand the stability window of water, which may enable the elimination of conventional separators while maintaining safe operation, thereby reducing component costs and simplifying cell assembly.

According to embodiments of the present disclosure, no bromine complexing agents may be employed, and the generated bromine and/or polybromide may be stably stored in the graphite electrode. The trapped Br₃⁻ and Br₂ within the graphite is believed to be essential to maintain stable capacity performances from the battery. This may eliminate the need for additional complexing agents, reducing electrolyte complexity and cost while maintaining stable electrochemical performance.

According to embodiments of the present disclosure, the water-in-salt electrolyte may have a concentration of 16 mol/L for LiCl, 5 mol/L for ZnCl₂, and 1 mol/L for KBr. During charge, one plateau was noticed, indicating that Br⁻ participation dominates over the H₂O/Cl⁻ involvement, thus favorably achieving an excellent cycle life for the battery up to 800 cycles. This optimized electrolyte composition may maximize bromide participation while minimizing undesirable chlorine evolution and water oxidation reactions.

According to embodiments of the present disclosure, the graphite foil of the cathode may be subjected to a surface cleaning process comprising: immersing the graphite foil in a sulfuric acid aqueous solution at 80° C. for 2 hours, subsequently soaking it in distilled water overnight, washing it repeatedly with distilled water and ethanol, and finally drying it in an oven at 70° C. for 8 hours. This surface treatment may remove impurities and prepare the graphite surface for optimal electrochemical performance and enhanced bromine intercalation.

According to embodiments of the present disclosure, the floating-type cell configuration may use acrylic plates as the cell case, silicon rubber as the gasket to maintain a safe distance, and titanium foil to establish electrical contact with the cathode and anode electrodes. Silicon rubber was employed as a gasket to maintain a safe separation distance between the graphite and Zn foils and to prevent electrolyte leakage. This configuration may provide a robust, leak-proof cell assembly with reliable electrical connections and controlled electrode spacing.

According to embodiments of the present disclosure, the battery may have a coulombic efficiency of not less than 91%, may achieve at least 800 cycles when the anode is zinc foil, and at least 1100 cycles when the anode host electrode is graphite foil. The ZnGB ran for 800 repeated cycles, and Zn metal-free ZnGB ran with enhanced cycles up to 1100 without noticeable performance decay. This extended cycle life may make the battery suitable for long-term energy storage applications requiring high durability.

According to embodiments of the present disclosure, during charging, bromide ions from the WiSE may be oxidized to bromine at the cathode and zinc ions from the WiSE may be deposited as metallic zinc at the anode, and during discharging, the reactions at the cathode and anode may be reversed. The reactions occurred during the charge are electrochemically reversible during the discharge. This reversible electrochemistry may enable stable, repeatable charge-discharge cycling with high coulombic efficiency.

According to embodiments of the present disclosure, during charging, the cathode may undergo electrochemical oxidation of bromide ions into bromine and conversion of the bromine into tribromide, and intercalation of bromine between graphene layers of the graphite foil. The increase in Raman spectra intensity of tribromide and Br₂ peaks during the charge indicates the involvement of a two-kind charging process at the graphite electrode, involving the electrochemical oxidation of Br⁻ into Br₂ and its conversion into tribromide and Br₂ intercalation via tribromide. This dual storage mechanism may provide enhanced capacity compared to single-mechanism approaches.

According to embodiments of the present disclosure, the battery may achieve a high-power density of up to 199.5 mW/cm². The achieved maximum power density value of 199.15 mW/cm² is higher than or closer to redox flow batteries reported elsewhere. This high-power density may enable rapid energy delivery for applications requiring high power output.

According to embodiments of the present disclosure, the battery may achieve an areal capacity of up to 5 mAh/cm². The discharge capacity showed stabilization after 15 cycles, reaching a significant discharge capacity and voltage of 4.61 mAh/cm² and 1.65 V, respectively. This marks the highest areal capacity achieved for the graphite electrode or among the reported ZnGBs. This high areal capacity may enable compact battery designs with high energy density.

According to embodiments of the present disclosure, the battery may operate at current densities up to 150 mA/cm². High current operation is crucial for the batteries for large-scale energy storage applications, enabling rapid energy storage and high-power density. This high current capability may enable fast charging and discharging for demanding energy storage applications.

According to embodiments of the present disclosure, the battery may achieve a discharge cell voltage of approximately 1.67 V. The estimated cell voltage for ZnGB is approximately 1.81 V, which is closer to the theoretical cell voltage of the Zn—Br⁻/Br₂ battery (1.84 V). This operating voltage may provide a favorable balance between energy density and electrochemical stability.

According to embodiments of the present disclosure, when the anode is graphite foil, the graphite foil at the negative electrode may serve as a current collector, facilitating zinc deposition and subsequent dissolution. In this configuration, the graphite foil at the negative electrode serves as the current collector, facilitating Zn deposition and subsequent dissolution. This zinc anode-free configuration may reduce material costs and improve cycle life by eliminating issues associated with zinc metal anodes such as dendrite formation.

There is provided, according to a second aspect of the present disclosure, a method for preparing a bipolar-type zinc-graphite battery based on bromine chemistry enabled by water-in-salt electrolyte, comprising: preparing a cathode host comprising graphite foil, which undergoes electrochemical reactions involving bromide ions; preparing an anode selected from zinc foil or graphite foil that serves as a current collector for zinc deposition and dissolution; preparing a water-in-salt electrolyte (WiSE) comprising lithium chloride (LiCl), zinc chloride (ZnCl₂), and potassium bromide (KBr), wherein the WiSE provides bromide ions for cathodic reactions and zinc ions for anodic reactions; assembling the cathode, the anode, and the water-in-salt electrolyte to obtain the bipolar-type zinc-graphite battery, wherein a safe distance is maintained between the cathode and anode to prevent short circuits and dendrite growth.

According to embodiments of the present disclosure, the bipolar-type zinc-graphite battery obtained by assembly delivers the capacity of 10.60 mAh, and the cell voltage of 6.64 V.

It will be appreciated that features disclosed in relation to one aspect of the present disclosure may be applicable to other aspects of the present disclosure, and vice versa.

### BRIEF DESCRIPTION OF THE DRAWINGS

The manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 shows a schematic illustration of a zinc-graphite battery employing zinc-halogen chemistry and its corresponding electrochemical process, according to an embodiment of the present disclosure.

FIG. 2 shows electrochemical studies of a graphite electrode, a zinc electrode, and zinc-graphite batteries, including: (a) a cyclic voltammetry (CV) curve of graphite tested in different electrolytes; (b) a CV curve of graphite and zinc electrode measured in the specified water-in-salt electrolyte; (c) a CV curve of a zinc-graphite battery tested with the specified water-in-salt electrolyte; (d) cyclability comparison of zinc-graphite batteries; (e) comparison of charge and discharge profiles of zinc-graphite batteries at a selected cycle; and (f) cycle number plotted against discharge cell voltage and energy density for a zinc-graphite battery tested in the specified water-in-salt electrolyte, according to an embodiment of the present disclosure.

FIG. 3 shows various electrochemical studies of a zinc-graphite battery using the specified water-in-salt electrolyte, including: (a) rate capability measured by varying charge and discharge current densities; (b) rate capability measured by charging at a fixed current density followed by discharging at different current densities; (c) charge and discharge profiles at various charge and discharge current densities; (d) charge and discharge profiles where the charge profile is at a fixed current density and the discharging profile is at different current densities; (e) polarization and power density performance of a charged battery after different cycles; (f) selective charge and discharge profiles tested under a charge capacity cut-off condition; and (g) cyclability performance under the charge capacity cut-off condition at a fixed current density, according to an embodiment of the present disclosure.

FIG. 4 shows electrochemical studies of a zinc metal anode-free zinc-graphite battery and a four-cell stacked zinc metal anode-free zinc-graphite battery, including: (a) representative charge and discharge profiles at different cycles; (b) cycle number versus discharge capacity and coulombic efficiency; (c) polarization and power density performance; (d) representative charge and discharge profiles of the stacked battery at different cycles; (e) cycle number versus discharge capacity and coulombic efficiency of the stacked battery; and (f) an image of a charged four-cell stacked zinc metal anode-free zinc-graphite battery and its demonstration of powering an LED bulb, according to an embodiment of the present disclosure.

FIG. 5 shows ex-situ characterization of a graphite electrode, including: (a) ex-situ Raman spectra after full charge and discharge and comparison with ex-situ Raman spectra of pristine electrolyte; (b) ex-situ Raman spectra at different percentages of state of charge (SOC); (c) ex-situ XPS core level Br3d spectra; and (d) ex-situ XPS core level C1s spectra, wherein all results for the graphite electrode are collected after a selected number of cycles, according to an embodiment of the present disclosure.

FIG. 6 shows: (a) through (d) SEM images of a graphite electrode before cycling and after cycles; (e) an illustration of graphite electrode changes with cycles; and (f) an illustration of charge and discharge processes at the graphite electrode after stabilized cycles, according to an embodiment of the present disclosure.

FIG. 7 shows Raman spectra (a) and (b) and FTIR spectra (c) of different electrolyte solutions and water, according to an embodiment of the present disclosure.

FIG. 8 shows the first representative charge and discharge profiles of a zinc-graphite battery tested in various electrolytes at a fixed current density, according to an embodiment of the present disclosure.

FIG. 9 shows current density versus energy density, wherein the energy densities were calculated corresponding to results shown in FIGS. 2c and d, according to an embodiment of the present disclosure.

FIG. 10 shows polarization and power density performance of a zinc-graphite battery using the specified water-in-salt electrolyte at different charged capacities, wherein the results were collected after charge and discharge cycles at a fixed current density, according to an embodiment of the present disclosure.

FIG. 11 shows: (a) and (b) images of an assembled bipolar electrode-type zinc anode-free battery; and (c) a schematic image of the assembled battery and the manner in which it is assembled, according to an embodiment of the present disclosure.

FIG. 12 shows in-situ Raman spectra of a graphite electrode using a quartz cuvette-assembled cell and comparison with ex-situ Raman spectra of the specified water-in-salt electrolyte, according to an embodiment of the present disclosure.

FIG. 13 shows selective charge and discharge profiles and cyclability of a battery tested using carbon cloth and graphite plate, wherein the specified water-in-salt electrolyte was used commonly in both batteries, according to an embodiment of the present disclosure.

FIG. 14 shows: (a) ex-situ XRD results of a graphite electrode; (b) ex-situ Raman spectra of the specified water-in-salt electrolyte; and (c) pH of the specified water-in-salt electrolyte, according to an embodiment of the present disclosure.

FIG. 15 shows an image of an assembled floating-type battery cell used in this work with cell component information, according to an embodiment of the present disclosure.

FIG. 16 shows electrochemical charge and discharge cycle studies of a zinc-graphite battery with the specified water-in-salt electrolyte at different capacities, including charge and discharge profiles and cycles tested at different capacity levels, according to an embodiment of the present disclosure.

The foregoing and other objects, features and advantages of the present invention, as well as the invention itself, will be more fully understood from the following description of preferred embodiments, when read together with the accompanying drawings.

### DETAILED DESCRIPTION

The present disclosure relates to the field of electrochemical energy storage, and more particularly to zinc-graphite batteries utilizing bromine chemistry enabled by water-in-salt electrolytes.

In the following detailed description of illustrative embodiments of the disclosure, specific embodiments in which the disclosure may be practiced are described in sufficient detail to enable those skilled in the art to practice the disclosed embodiments. The following detailed description is not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

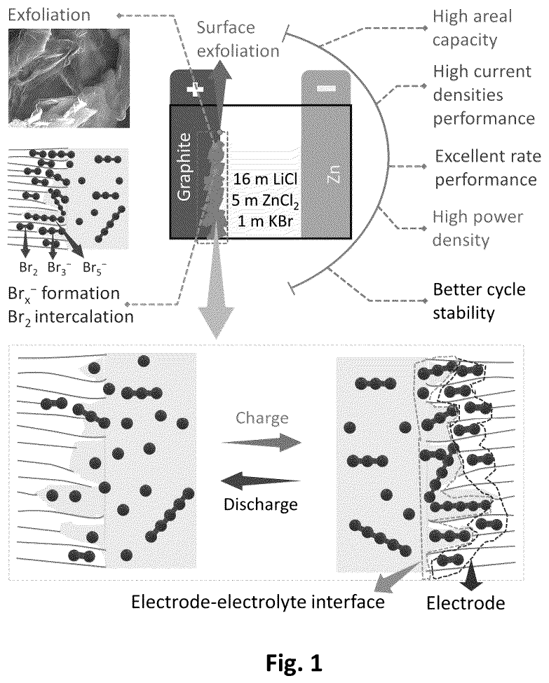

Referring to FIG. 1, there is shown a schematic illustration of a zinc-graphite battery according to an embodiment of the present disclosure. FIG. 1 illustrates the Zn-halogen chemistry employed in the zinc-graphite battery and its corresponding electrochemical process. The battery comprises a zinc foil serving as a negative electrode and a graphite foil serving as a positive electrode. Both electrodes are immersed in a water-in-salt electrolyte (WiSE) comprising LiCl/ZnCl₂/KBr. The WiSE serves as a medium that provides Zn²⁺ cations and Br⁻ anions for the anodic and cathodic electrochemical reactions, respectively.

FIG. 1 shows a schematic illustration of the zinc-graphite battery and its Zn-halogen chemistry-based electrochemical process. The battery includes a zinc foil as the negative electrode and a graphite foil as the positive electrode, both immersed in a water-in-salt electrolyte (WiSE) consisting of LiCl, ZnCl₂, and KBr. The WiSE functions as a medium to supply Zn²⁺ cations for anodic reactions and Br⁻ anions for cathodic reactions. During charging, the graphite cathode undergoes two key reactions: oxidation of Br⁻ ions to Br₂ and their conversion to tribromide (Br₃⁻) , followed by Br₂ intercalation between graphene layers; simultaneously, Zn²⁺ ions deposit as metallic Zn on the negative electrode. These reactions are reversible during discharge. The WiSE in the battery has a composition of 16 mol/L LiCl, 5 mol/L ZnCl₂, and 1 mol/L KBr, which efficiently provides Br⁻ ions for the conversion-intercalation process at the graphite electrode. Surface exfoliation of the graphite electrode, along with polybromide (Br₂⁻) formation and Br2 intercalation, contributes to the high performance of the battery.

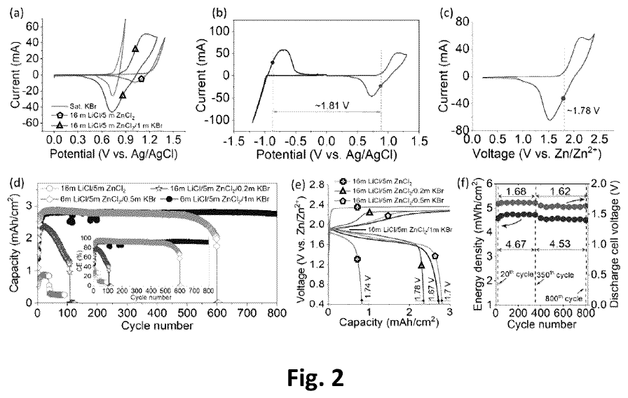

FIG. 2 shows electrochemical studies of the graphite electrode, zinc electrode, and zinc-graphite batteries. FIG. 2(a) presents cyclic voltammetry (CV) curves of the graphite electrode tested in different electrolytes at 2 mV/s, including 16 mol/L LiCl/5 mol/L ZnCl₂ WiSE with and without KBr, and saturated KBr electrolyte. The graphite electrode in 16 mol/L LiCl/5 mol/L ZnCl₂ WiSE exhibits a gas evolution-like peak with poor reversibility, while the addition of 1 mol/L KBr results in distinct redox peaks with excellent reversibility, corresponding to the Br redox process. In saturated KBr electrolyte, the Br redox process shows poor reversibility.

FIG. 2(b) illustrates CV curves of the graphite and Zn electrodes in 16 mol/L LiCl/5 mol/L ZnCl₂/1 mol/L KBr WiSE at 2 mV/s, with the estimated cell voltage close to the theoretical value of the Zn—Br⁻/Br₂ battery. FIG. 2(c) shows the CV curve of the zinc-graphite battery using the same WiSE at 5 mV/s, displaying a distinct Br-related redox peak and a achievable cell voltage.

FIG. 2(d) provides a cyclability comparison of zinc-graphite batteries at a specific current density, with the inset showing cycle number versus coulombic efficiency (CE). Batteries with different KBr concentrations in WiSE exhibit varying cycle lives, with the 16 mol/L LiCl/5 mol/L ZnCl₂/1 mol/L KBr WiSE enabling up to 800 cycles.

FIG. 2(e) compares charge and discharge profiles at the 20th cycle, showing that the battery with 1 mol/L KBr has a stable discharge capacity and CE not less than 91%. FIG. 2(f) plots cycle number against discharge cell voltage and energy density, confirming stable performance with cycles when Br is stored in graphite.

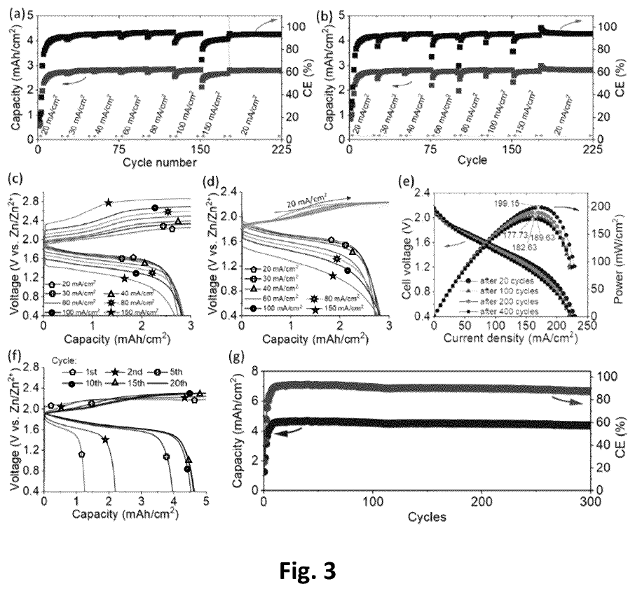

FIG. 3 shows various electrochemical studies of the zinc-graphite battery using 16 mol/L LiCl/5 mol/L ZnCl₂/1 mol/L KBr WiSE. FIG. 3(a) depicts the rate capability by varying charge and discharge current densities, with minimal capacity and CE decrease even at high current densities, and recovery of performance when returning to a lower current density.

FIG. 3(b) shows rate capability when charging at a fixed current density and discharging at different current densities, demonstrating excellent discharge rate performance. FIG. 3(c) presents charge and discharge profiles at various current densities, with no significant capacity decrease but an increase in the voltage gap between charge and discharge.

FIG. 3(d) illustrates charge and discharge profiles with a fixed charge current density and varying discharge current densities, showing higher voltage efficiency (VE) and energy efficiency (EE) compared to FIG. 3(c). FIG. 3(e) shows polarization and power density performance of the charged battery after different cycles, maintaining a competitive high-power density even after 400 cycles.

FIG. 3(f) displays selective charge and discharge profiles under a charge capacity cut-off condition, and FIG. 3(g) shows cyclability under the same condition, with the discharge capacity stabilizing after 15 cycles and maintaining good performance over 300 cycles.

FIG. 4 shows electrochemical studies of the zinc metal anode-free zinc-graphite battery and the four-cell stacked zinc metal anode-free zinc-graphite battery. FIG. 4(a) presents representative charge and discharge profiles at different cycles, with discharge capacity and CE improving with cycles and reaching values comparable to batteries with Zn metal anodes.

FIG. 4(b) plots cycle number versus discharge capacity and CE, showing the battery can achieve at least 1100 cycles. FIG. 4(c) illustrates polarization and power density performance, with stable power density over cycles.

FIG. 4(d) shows charge and discharge profiles of the four-cell stacked battery at different cycles, with increasing capacity and CE over cycles. FIG. 4(e) plots cycle number versus discharge capacity and CE for the stacked battery, maintaining good cyclability over 80 cycles. FIG. 4(f) shows an image of the charged four-cell stacked battery 100 powering a 5 V/5 W LED bulb 101, demonstrating its practical application potential.

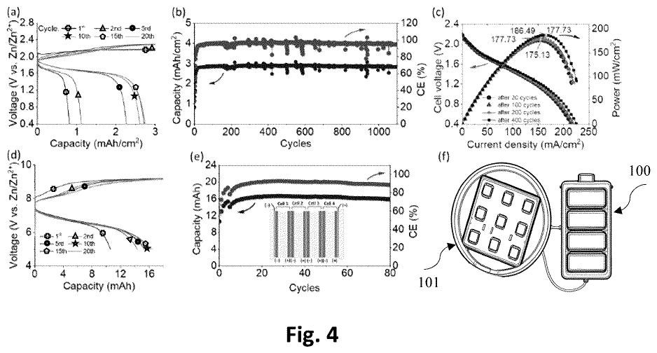

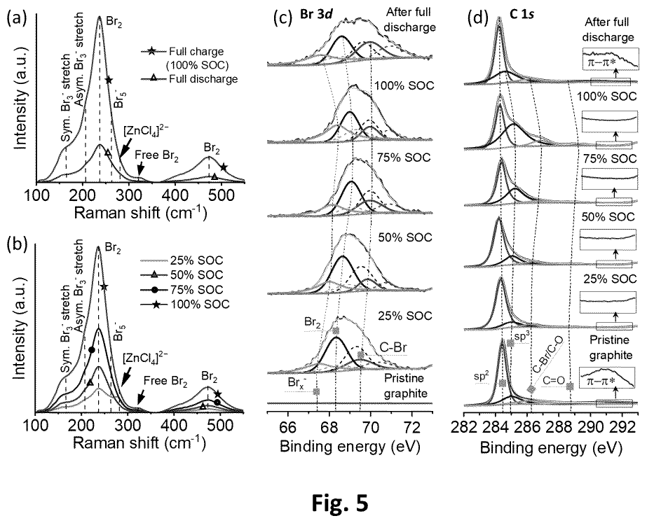

FIG. 5 shows in-situ and ex-situ characterization of the graphite electrode. FIG. 5(a) presents ex-situ Raman spectra after full charge and discharge, compared with the pristine electrolyte, revealing peaks corresponding to intercalated Br₂, polybromide (Br₃⁻ and Br₅⁻) , and free Br₂. FIG. 5(b) shows ex-situ Raman spectra at different states of charge (SOC), with peak intensities increasing with SOC and decreasing after discharge, indicating reversible formation and intercalation of Br species. Trapped Br₃⁻ and Br₂ within the graphite are believed to be essential for stable capacity. FIG. 5(c) shows ex-situ XPS core level Br3d spectra at various SOCs. FIG. 5(d) presents ex-situ XPS core level C1s spectra, wherein all results for the graphite electrode are collected after a selected number of cycles.

In some embodiments, the increase in Raman spectra intensity of tribromide and Br₂ peaks during the charge indicates the involvement of a two-kind charging process at the graphite electrode. This process involves the electrochemical oxidation of Br⁻ into Br₂ and its conversion into polybromide (Brₓ⁻) (equation 1 and 2) and Br₂ intercalation (equation 3):

2Br⁻→Br₂+2e⁻ (equation 1)

Br₂+Br⁻→Br₃⁻⇒Br₃⁻+Br₂→Br₅⁻(Brₓ⁻(x=2n+1)) (equation 2)

Br₂+C₆→C₆[Br₂] (equation 3)

The reactions (equations 1-3) occurred during the charge are electrochemically reversible during the discharge. Tribromide formation upon charging could occur at the surface of the graphite or within the graphite electrode. Br₂ intercalation takes place between the graphene layers of the graphite electrode. The surface of the graphite electrode was washed with dimethyl sulfoxide (DMSO) and subjected to Raman analysis. The Raman spectra still show Br₃⁻ peaks at all different charge states, confirming that the formed Br₃⁻ could be confined in graphite electrode. BrCl complex was not observed in both in-situ and ex-situ Raman studies. Even though Br₃⁻ is seen as a drawback in the Br-based batteries, the observed two-kind reaction within the graphite electrode offers a high-performance battery with good cyclability.

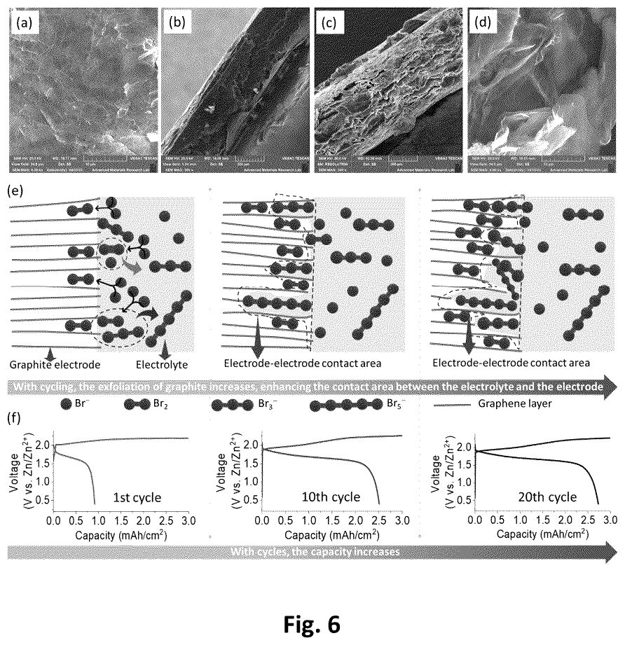

FIG. 6 shows SEM images and illustrations of the graphite electrode. FIGS. 6(a) and (b) are SEM images of the graphite electrode before cycling, showing a relatively smooth surface. FIGS. 6(c) and (d) are SEM images after 20 cycles, revealing surface and edge exfoliation of the graphite electrode.

FIG. 6(e) illustrates the changes in the graphite electrode with cycles, where appropriate exfoliation increases the electrolyte-electrode contact area and retains sufficient Br₃⁻/Br₅⁻ and Br₂ intercalation, ensuring stable electrochemical performance. FIG. 6(f) illustrates the charge and discharge processes at the graphite electrode after stabilized cycles, leading to high-capacity reversibility.

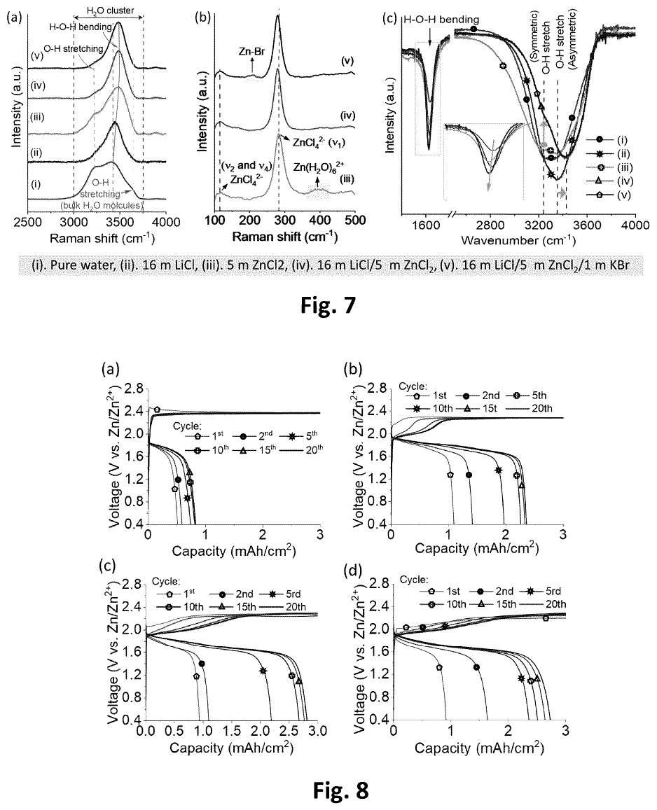

FIG. 7 shows Raman spectra (FIGS. 7(a) and (b)) and FTIR spectra (FIG. 7(c)) of different electrolyte solutions and water. The Raman spectra of 16 mol/L LiCl/5 mol/L ZnCl₂ WiSE with and without 1 mol/L KBr are similar, with a small peak indicating Zn—Br and Zn—Br—Cl complexes in the WiSE with KBr. The FTIR spectrum of 16 mol/L LiCl/5 mol/L ZnCl₂/1 mol/L KBr WiSE shows changes in O—H stretching and H—O—H bending vibrations compared to pure water and 5 mol/L ZnCl₂ solution, indicating disruption of the hydrogen bonding network and formation of ionic clusters. Peaks related to ZnCl₄²⁻ are observed, suggesting it is the main source of Zn ions for anodic reactions, and no peaks related to electrochemically non-active species are found, avoiding unwanted side reactions.

FIG. 8 shows the first 20 representative charge and discharge profiles of the zinc-graphite battery tested in various electrolytes at a fixed current density. FIGS. 8(a) to (d) correspond to electrolytes with 0, 0.2, 0.5, and 1 mol/L KBr in 16 mol/L LiCl/5 mol/L ZnCl₂ WiSE, respectively. In all cases, the discharge capacity improves with cycles, particularly in the first 20 cycles, with the electrolyte containing 1 mol/L KBr showing the most stable and highest performance.

FIG. 9 shows the relationship between current density and energy density, calculated based on results from FIG. 3(c) and FIG. 3(d). The battery achieves relatively stable energy densities at different current densities, with a moderate energy density loss when increasing the current density from low to high values.

FIG. 10 shows polarization and power density performance of the zinc-graphite battery using 16 mol/L LiCl/5 mol/L ZnCl₂/1 mol/L KBr WiSE at different charged capacities. These results are collected after 20 charge and discharge cycles at a fixed current density. As the charged capacity increases, the peak power density and open-circuit voltage (OCV) both increase, with the maximum power density reaching up to 199.5 mW/cm², which is competitive compared to other reported redox flow batteries.

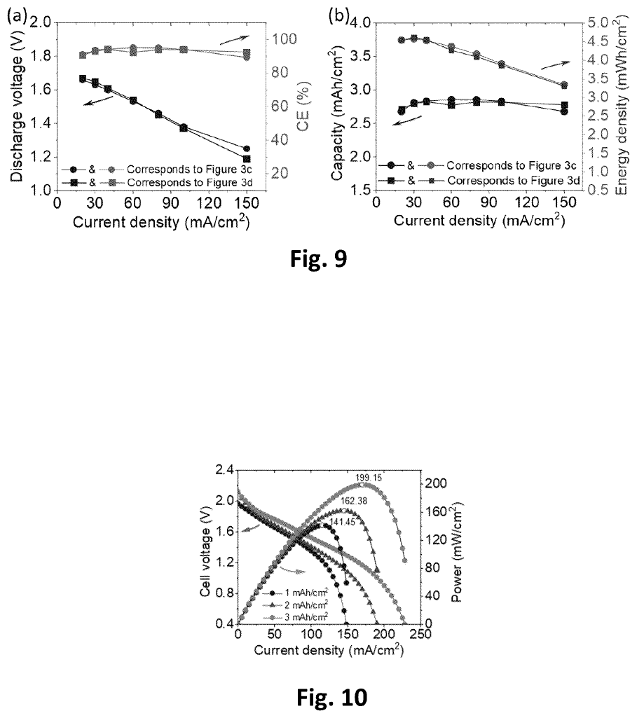

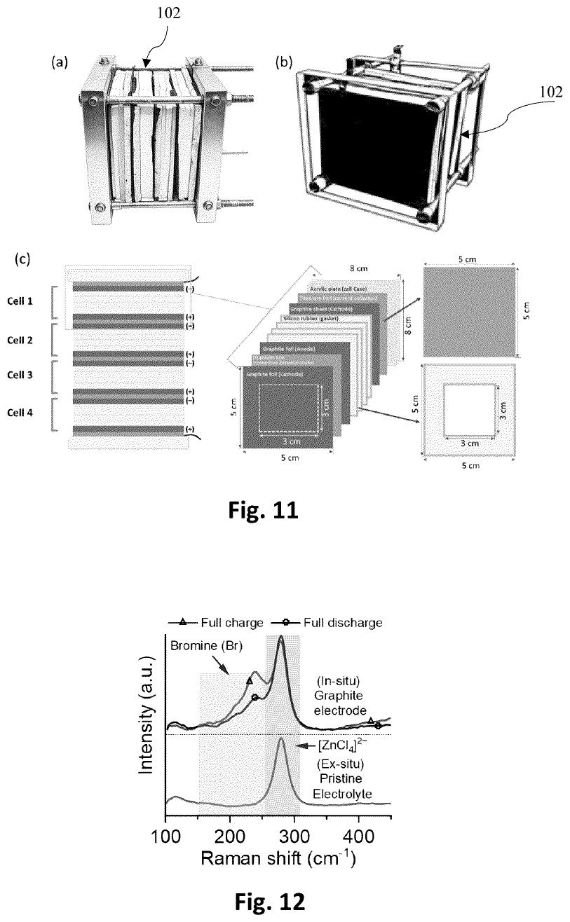

FIG. 11 shows images and a schematic of the assembled bipolar electrode-type zinc anode-free battery 102. FIGS. 11(a) and (b) are images of the assembled battery, and FIG. 11(c) is a schematic illustrating the assembly manner. The battery consists of four cells, using the optimized 16 mol/L LiCl/5 mol/L ZnCl₂/1 mol/L KBr WiSE and graphite foils as both anode and cathode active materials. It undergoes galvanostatic charge and discharge cycles with specified cut-off capacity and voltage.

FIG. 12 shows in-situ Raman spectra of the graphite electrode using a quartz cuvette-assembled cell, compared with ex-situ Raman spectra of 16 mol/L LiCl/5 mol/L ZnCl₂/1 mol/L KBr WiSE. After full charge, two distinct regions corresponding to [ZnCl₄]²⁻ and Br are observed. The intensity of the Br peak decreases significantly after full charge, while the [ZnCl₄]²⁻ peak remains unchanged. Due to the combined signal of the electrolyte and graphite electrode in the in-situ study, ex-situ Raman analysis provides more insights into the Br storage mechanism.

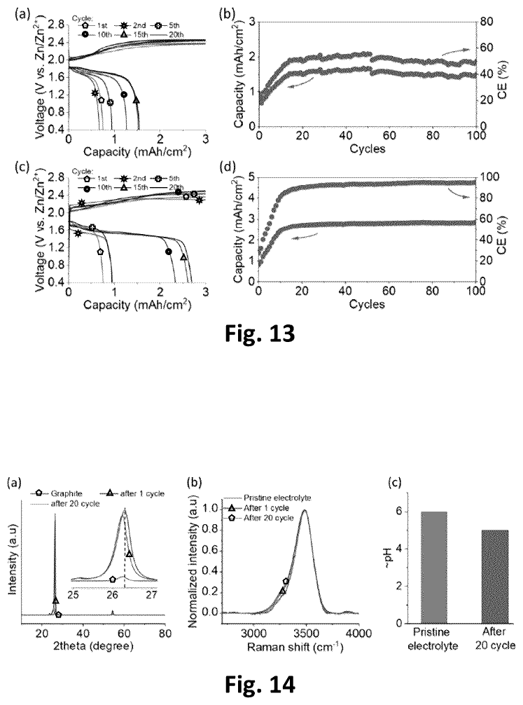

FIG. 13 shows selective charge and discharge profiles and cyclability of batteries tested using carbon cloth and graphite plate, both with 16 mol/L LiCl/5 mol/L ZnCl₂/1 mol/L KBr WiSE. FIGS. 13(a) and (b) correspond to carbon cloth, and FIGS. 13(c) and (d) correspond to graphite plate. Carbon cloth, despite its high surface area, exhibits poor capacity performance compared to graphite foil and graphite plate due to its poor graphitic nature and limited Br₂ intercalation ability. This highlights the importance of the graphitic nature of the electrode for utilizing Br₃⁻ for Br₂ intercalation and achieving good capacity performance from the 20th cycle onwards.

FIG. 14 shows characterization results of the graphite electrode and the electrolyte. FIG. 14(a) presents ex-situ XRD results of the graphite electrode after 20 cycles, showing decreased peak intensity and a decrease in 2θ value, indicating disordered graphite formation and increased d-spacing between graphene layers. FIG. 14(b) shows ex-situ Raman spectra of 16 mol/L LiCl/5 mol/L ZnCl₂/1 mol/L KBr WiSE, with no notable changes in the characteristic region, indicating the electrolyte retains its properties. FIG. 14(c) shows the pH of the WiSE, which slightly decreases after cycles but still supports good electrochemical performance.

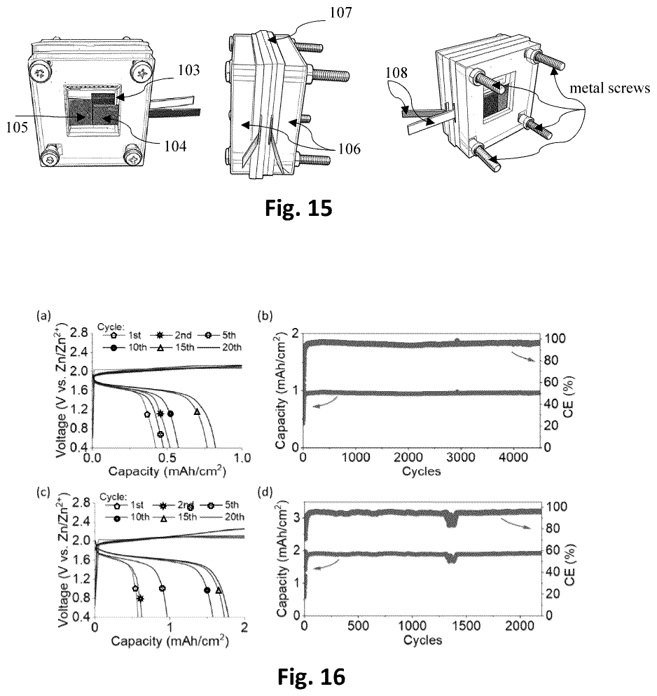

FIG. 15 shows an image of the assembled floating-type battery cell with component labels. The graphite foil cathode 103 undergoes a surface cleaning process: immersing in a sulfuric acid aqueous solution at 80° C. for 2 hours, soaking in distilled water overnight, washing repeatedly with distilled water and ethanol, and drying in an oven at 70° C. for 8 hours. The zinc foil anode is marked as 104, and the WiSE is marked as 105. The floating-type cell configuration uses acrylic plates 106 as the cell case, silicon rubber 107 as the gasket to maintain a safe distance between electrodes and prevent electrolyte leakage, and titanium foil 108 to establish electrical contact with the cathode and anode. The specified geometrical area of the graphite foil is used as the cathode, and the electrodes are immersed in a fixed volume of electrolyte with a specific gap.

FIG. 16 shows electrochemical charge and discharge cycle studies of the zinc-graphite battery with 16 mol/L LiCl/5 mol/L ZnCl₂/1 mol/L KBr WiSE at different capacities. FIGS. 16(a) and (b) show charge and discharge profiles and cycles tested at 1 mAh/cm², and FIGS. 16(c) and (d) show those tested at 2 mAh/cm². The battery exhibits stable charge and discharge behavior at different capacity levels, with consistent performance over cycles.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. The disclosures and the description herein are intended to be illustrative and are not in any sense limiting the present disclosure, defined in scope by the following claims.

1. A zinc-graphite battery based on bromine chemistry enabled by water-in-salt electrolyte, comprising:
a graphite foil selected to serve as a cathode host for the electrochemical reactions involving bromide ions;
an anode selected from zinc foil or graphite foil that serves as a current collector for zinc deposition and dissolution; and
a water-in-salt electrolyte (WiSE) comprising lithium chloride (LiCl), zinc chloride (ZnCl₂), and potassium bromide (KBr), wherein the WiSE provides bromide ions for cathodic reactions and zinc ions for anodic reactions.

2. The zinc-graphite battery according to claim 1, wherein the graphite foil is directly used as a cathode host material without comprising a binder or a carrier.

3. The zinc-graphite battery according to claim 1, comprising a floating-type cell configuration without a separator or membrane, wherein a safe distance is maintained between the cathode and the anode.

4. The zinc-graphite battery according to claim 1, wherein no bromine complexing agents are employed, and the generated bromine and/or polybromide are stably stored in the graphite electrode.

5. The zinc-graphite battery according to claim 1, wherein the water-in-salt electrolyte has a concentration of 16 mol/L for LiCl, 5 mol/L for ZnCl₂, and 1 mol/L for KBr.

6. The zinc-graphite battery according to claim 1, wherein the graphite foil of the cathode is subjected to a surface cleaning process comprising: immersing the graphite foil in a sulfuric acid aqueous solution at 80° C. for 2 hours, subsequently soaking it in distilled water overnight, washing it repeatedly with distilled water and ethanol, and finally drying it in an oven at 70° C. for 8 hours.

7. The zinc-graphite battery according to claim 3, wherein the floating-type cell configuration uses acrylic plates as the cell case, silicon rubber as the gasket to maintain a safe distance, and titanium foil to establish electrical contact with the cathode and anode electrodes.

8. The zinc-graphite battery according to claim 1, wherein the battery has a coulombic efficiency of not less than 91%, can achieve at least 800 cycles when the anode is zinc foil, and at least 1100 cycles when the anode host electrode is graphite foil.

9. A method for preparing a bipolar-type zinc-graphite battery based on bromine chemistry enabled by water-in-salt electrolyte, comprising the following steps:
a) preparing a cathode host comprising graphite foil, which undergoes electrochemical reactions involving bromide ions;
b) preparing an anode selected from zinc foil or graphite foil that serves as a current collector for zinc deposition and dissolution;
c) preparing a water-in-salt electrolyte (WiSE) comprising lithium chloride (LiCl), zinc chloride (ZnCl₂), and potassium bromide (KBr), wherein the WiSE provides bromide ions for cathodic reactions and zinc ions for anodic reactions;
d) assembling the cathode, the anode, and the water-in-salt electrolyte to obtain the bipolar-type zinc-graphite battery.

10. The method according to claim 9, wherein the graphite foil is directly used as a cathode host material without comprising a binder or a carrier.

11. The method according to claim 9, wherein the assembled bipolar-type zinc-graphite battery has a configuration without a separator or membrane, and a safe distance is maintained between the cathode and anode during assembly.

12. The method according to claim 9, wherein no bromine complexing agents are employed in the preparation process, and the generated bromine and/or polybromide in the assembled battery are stably stored in the graphite electrode.

13. The method according to claim 9, wherein the cathode and the anode, together with a titanium foil, are assembled to form a bipolar electrode structure, with one side for bromide redox reactions and the other for zinc redox reactions, when the anode prepared in step b) is graphite foil.

14. The method according to claim 9, wherein the water-in-salt electrolyte prepared in step c) has a concentration of 16 mol/L for LiCl, 5 mol/L for ZnCl₂, and 1 mol/L for KBr.

15. The method according to claim 9, wherein the graphite foil of the cathode in step a) is subjected to a surface cleaning process comprising: immersing the graphite foil in a sulfuric acid aqueous solution at 80° C. for 2 hours, subsequently soaking it in distilled water overnight, washing it repeatedly with distilled water and ethanol, and finally drying it in an oven at 70° C. for 8 hours.

16. The method according to claim 11, wherein when assembling the bipolar-type battery configuration, acrylic plates are used as the cell case, silicon rubber is used as the gasket to maintain a safe distance, and titanium foil is used to establish electrical contact with the cathode and anode.

17. The method according to claim 9, wherein the bipolar-type zinc-graphite battery obtained by assembly delivers the capacity of 10.60 mAh, and the cell voltage of 6.64 V.
